(19) United States
(12) Patent Application Publication
(10) Pub. No.: US 2025/0374330 A1
(43) Pub. Date: Dec. 4, 2025

(54) DEVICE AND METHOD FOR PROCESSING RANDOM ACCESS REPORT ABOUT RANDOM ACCESS CONFIGURATION AND RANDOM ACCESS PROCESSING FOR SUPPORTING SPECIFIC FUNCTION IN WIRELESS COMMUNICATION SYSTEM

(71) Applicant: SAMSUNG ELECTRONICS CO., LTD., Suwon-si, Gyeonggi-do (KR)

(72) Inventors: Hyunjeong KANG, Suwon-si (KR); Anil AGIWAL, Suwon-si (KR); Sangbum KIM, Suwon-si (KR)

(21) Appl. No.: 18/876,160

(22) PCT Filed: Jun. 13, 2023
(86) PCT No.: PCT/KR2023/008084

§ 371 Date: Dec. 17, 2024

(30) Foreign Application Priority Data
Jun. 17, 2022 (KR) 10-2022-0074000

(51) Int. Cl. H04W 74/0833

(52) U.S. Cl. CPC H04W 74/0833

(57) ABSTRACT

The present disclosure relates to a 5G or 6G communication system for supporting higher data transmission rates. A method performed in a wireless communication system by a terminal disclosed herein comprises the steps of: acquiring, from a base station, random access configuration parameters for a combination of a plurality of functions; using the acquired random access configuration parameters to perform a random access procedure; and transmitting a random access report about the performed random access procedure to the base station, wherein the random access report includes random access configuration information on at least one function, used when the random access procedure was performed, among the plurality of functions.

### TECHNICAL FIELD

The present disclosure relates to a wireless communication system, and more particularly, to a procedure method and device for operations of performing random access according to the random access configuration corresponding to each function when a terminal receiving services corresponding to various functions such as network slicing, reduced UE capability (REDCAP), small data transmission, and coverage enhancement, performs a random access procedure, and of reporting the processing of the random access to a network.

### BACKGROUND ART

5G mobile communication technologies define broad frequency bands to provide higher transmission rates and new services, and can be implemented in “Sub 6 GHz” bands such as 3.5 GHz, and also in “above 6 GHz” bands, which may be referred to as mmWave bands including 28 GHz and 39 GHz. In addition, the implementation of 6G mobile communication technologies, which may be called a Beyond 5G system, in terahertz bands (e.g., 95 GHz to 3THz bands) has been considered in order to achieve transmission rates fifty times faster than 5G mobile communication technologies and ultra-low latencies reduced to one-tenth of 5G mobile communication technologies. In the beginning of 5G mobile communication technologies, in order to support services and to satisfy performance requirements in connection with enhanced Mobile Broadband (eMBB), Ultra-Reliable Low-Latency Communications (URLLC), and massive Machine-Type Communications (mMTC), there had been ongoing standardization regarding Beamforming and massive multi-input multi-output (MIMO) for mitigating radio-wave path loss and increasing radio-wave transmission distances in mmWave, supporting various numerologies (e.g., operating a plurality of subcarrier spacings) for efficiently utilizing mmWave resources and dynamic operation of slot formats, initial access technologies for supporting multi-beam transmission and broadbands, definition and operation of a Bandwidth Part (BWP), new channel coding methods such as a Low Density Parity Check (LDPC) code for large amount of data transmission and a polar code for highly reliable transmission of control information, layer 2 (L2) pre-processing, and Network Slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-To-Everything (V2X) for aiding driving determination by autonomous vehicles based on information regarding locations and states of vehicles transmitted by the vehicles and for enhancing user convenience, New Radio-Unlicensed (NR-U) aimed at system operations conforming to various regulation-related requirements in unlicensed bands, NR UE power saving, Non-Terrestrial Network (NTN), which is UE-satellite direct communication for providing coverage in an area in which communication with terrestrial networks is unavailable, and positioning, etc.

Moreover, there has been ongoing standardization in air interface architecture/protocol regarding technologies such as Industrial Internet Of Things (IIoT) for supporting new services through interworking and convergence with other industries, Integrated Access And Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR), etc., and there also has been ongoing standardization in system architecture/service regarding a 5G baseline architecture (e.g., Service based Architecture or Service based Interface) for combining Network Functions Virtualization (NFV) and Software-Defined Networking (SDN) technologies, and Mobile Edge Computing (MEC) for receiving services based on UE locations, etc.

As such 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, drone communication, and the like.

In addition, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technologies for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

On the other hand, network slicing technology, reduced UE capability (REDCAP) technology, small data transmission (SDT) technology, and coverage enhancement (CE) technology are introduced in 5G. Each network slice refers to a separate end-to-end network that is tailored to meet various requirements requested by specific applications. REDCAP technology is intended to serve terminals that support lower specifications than typical terminal capabilities, for example, terminals with only one antenna installed. SDT technology is intended to support the function of the terminal to transmit user traffic without maintaining an RRC connection mode to the network. CE technology is intended to support the function of the network to extend the coverage in which it can provide service to the terminal.

### DISCLOSURE

### Technical Problem

The present disclosure provides a device and method for a terminal in a wireless communication system to process random access configurations and random access configured for various functions and to report about random access. According to various embodiments of the present disclosure, various functions may include a network slice function, REDCAP function, SDT function, and CE function.

### Technical Solution

According to an embodiment of the present disclosure, a method performed by a terminal in a wireless communication system may comprise: acquiring, from a base station, random access configuration parameters for a combination of a plurality of functions; performing a random access procedure using the acquired random access configuration parameters; and transmitting, to the base station, a random access report about the performed random access procedure, wherein, the random access report includes random access configuration information on at least one function, used when the random access procedure was performed, among the plurality of functions.

Further, according to an embodiment of the present disclosure, a method performed by a base station in a wireless communication system may comprise: transmitting, to a terminal, random access configuration parameters for a combination of a plurality of functions; and receiving, from the terminal, a random access report about a random access procedure performed using the random access configuration parameters, wherein the random access report may include random access information on at least one function, used when the random access procedure was performed, among the plurality of functions.

Further, according to an embodiment of the present disclosure, a terminal in a wireless communication system may comprise:
a transceiver configured to transmit and receive signals; and a controller that controls to: acquire, from a base station, random access configuration parameters for a combination of a plurality of functions, perform a random access procedure using the acquired random access configuration parameters, and transmit, to the base station, a random access report about the performed random access procedure, wherein the random access report may include random access configuration information on at least one function, used when the random access procedure was performed, among the plurality of functions.

Further, according to an embodiment of the present disclosure, a base station in a wireless communication system may comprise:
a transceiver configured to transmit and receive signals; and transmitting, to a terminal, random access configuration parameters for a combination of a plurality of functions, and receiving, from the terminal, a random access report about a random access procedure performed using the random access configuration parameters, wherein the random access report may include random access information on at least one function, used when the random access procedure was performed, among the plurality of functions.

### Advantageous Effects

According to the present disclosure, based on the random access reports about various functions of the terminal, the network can identify random access configurations (e.g., usage information on the random access preamble resources, random access transmission resources, etc.) to be applied to the various functions, and the network can configure or reconfigure the random access configurations (e.g., random access preamble resources, random access transmission resources) to efficiently service the various functions. In this way, the terminal can be provided with the required services without delay, or the system access procedures performed by the terminal to obtain the required services can be handled efficiently.

The effects that may be obtained from the present disclosure are not limited to those mentioned above, and other effects not mentioned will be clearly understood by those having ordinary knowledge in the technical field to which the present disclosure belongs from the following description.

### DESCRIPTION OF DRAWINGS

The above and other objects, features and advantages of the present disclosure will become more apparent from the following description about the embodiments of the present disclosure with reference to the attached drawings.

FIG. 1 is a diagram illustrating a wireless communication system according to an embodiment of the present disclosure.

FIG. 2 is a diagram illustrating the constitution of a base station in a wireless communication system according to an embodiment of the present disclosure.

FIG. 3 is a diagram illustrating the constitution of a terminal in a wireless communication system according to an embodiment of the present disclosure.

FIG. 4 is a diagram illustrating the constitution of a communication unit in a wireless communication system according to an embodiment of the present disclosure.

FIG. 5 is a diagram illustrating the structure of wireless time-frequency resources of a wireless communication system according to an embodiment of the present disclosure.

FIG. 6 is a diagram illustrating signal flows between a terminal and a base station performing random access reporting for various functions according to an embodiment of the present disclosure.

FIG. 7 is a diagram illustrating an operation of a terminal performing random access reporting about various functions according to various embodiments of the present disclosure.

FIG. 8 is a diagram illustrating an operation of a terminal performing random access reporting about a network slice function according to various embodiments of the present disclosure.

FIG. 9 is a diagram illustrating an operation of a base station processing random access reports of a terminal for various functions according to various embodiments of the present disclosure.

FIG. 10 is a diagram illustrating signal flows between a terminal and a base station that process support information on random access reports for various functions according to various embodiments of the present disclosure.

### MODE FOR DISCLOSURE

Hereinafter, preferred embodiments of the present disclosure will be described in detail with reference to the accompanying drawings. In this case, it should be noted that in the attached drawings, identical components are indicated by identical symbols whenever possible. Additionally, detailed descriptions of well-known functions and configurations that may obscure the gist of the present disclosure will be omitted.

In describing the embodiments in this specification, description of technical content that is well known in the technical field to which the present disclosure belongs and that is not directly related to the present disclosure will be omitted. This is to convey the gist of the present disclosure more clearly without obscuring it by omitting unnecessary explanation.

For the same reason, some components are exaggerated, omitted, or schematically shown in the accompanying drawings. Additionally, the size of each component does not entirely reflect its actual size. In each drawing, identical or corresponding components are assigned the same reference numbers.

The advantages and features of the present disclosure and methods for achieving them will become clear with reference to the embodiments described in detail below in connection with the accompanying drawings. However, the present disclosure is not limited to the embodiments disclosed below and may be implemented in many different forms, and the present embodiments are merely intended to ensure that the disclosure is complete and to fully convey the scope of the disclosure, which is defined by the claims, to those of ordinary skill in the art to which the disclosure belongs. Like reference numerals refer to like components throughout the specification.

It will be appreciated at this point that each block of the processing flowchart illustrations and combinations of the flowchart illustrations may be carried out by computer program instructions. These computer program instructions may be loaded into a processor of a general purpose computer, a special purpose computer or other programmable data processing equipment so that the instructions, when executed by the processor of the computer or other programmable data processing equipment, produce means for performing the functions described in the flowchart block(s). Since these computer program instructions may be stored in a computer-readable or computer-available memory which may be directed to a computer or other programmable data processing equipment to implement the functionality in a particular manner, the instructions stored in the computer-readable or computer-available memory may produce an article of manufacture comprising the instructional means for performing the functions described in the flowchart block(s). Since the computer program instructions may also be loaded on a computer or other programmable data processing equipment, a series of operational steps are performed on the computer or other programmable data processing equipment to produce a computer-executable process, such that the instructions executing the computer or other programmable data processing equipment provide steps for performing the functions described in the flowchart block(s).

Additionally, each block may represent a module, segment, or portion of code that includes one or more executable instructions for executing specified logical function(s). Additionally, it should be noted that in some alternative examples of execution it is possible for the functions mentioned in the blocks to occur out of sequence. For example, it is possible for two blocks shown in succession to be performed substantially at the same time, or it is possible for the blocks to be performed in reverse order depending on the corresponding function sometimes.

In this case, the term ‘˜unit’ used in the embodiments refers to software or a hardware component such as FPGA or ASIC, and the ‘˜unit’ performs certain roles. However, ‘˜unit’ is not limited to software or hardware. The ‘˜unit’ may be configured to reside in an addressable storage medium and may be configured to reproduce one or more processors. Therefore, as an example, ‘˜unit’ refers to components such as software components, object-oriented software components, class components, and task components, processes, functions, properties, procedures, subroutines, segments of program code, drivers, firmware, microcode, circuitry, data, databases, data structures, tables, arrays, and variables. The functions provided within the components and ‘˜units’ may be combined into a smaller number of components and ‘˜units’ or may be further separated into additional components and ‘˜units’. Additionally, components and ‘˜units’ may be implemented to regenerate one or more CPUs within a device or a secure multimedia card.

While the embodiments of the present disclosure are described with particular reference to the radio access network New RAN (NR) and the core network Packet Core (5G system or 5G core network or NG Core: Next Generation Core) of the 5G mobile communications specification specified by 3GPP, a mobile communications specification standardization organization, the main points of the present disclosure may be applied, with minor modifications, to other communication systems having a similar technical background without departing substantially from the scope of the present disclosure, as will be possible at the discretion of a person skilled in the art having technical knowledge in the technical field of the present disclosure.

In the 5G system, in order to support network automation, the Network Data Collection and Analysis Function (NWDAF), which is a network function that provides the function of analyzing and providing data collected from the 5G network, can be defined. NWDAF can collect/store/analyze information from the 5G network and provide the results to an unspecified Network Function (NF), and the analysis results can be used independently by each NF.

For convenience of description below, some of the terms and designations defined in the 3rd Generation Partnership Project Long Term Evolution (3GPP) specifications (specifications for 5G, NR, LTE or similar systems) may be used herein. However, the present disclosure is not limited by such terms and designations and may be equally applicable to systems based on other specifications.

Hereinafter, the present disclosure relates to a device and method for transmitting a report about a function-specific random access procedure to a base station in case that a function-specific random access procedure is performed by a terminal in a wireless communication system. Particularly, the present disclosure relates to a device and method for performing a procedure wherein a terminal performs a random access procedure for slicing, small data transmission, coverage enhancement, and/or RedCap functions and transmits a status report to a base station when the random access procedure for the respective function is performed, and a procedure wherein the base station, upon receiving the status report about the random access procedure for the respective function from the terminal, performs an operation to adjust and/or readjust the random access configurations for the respective function.

In the following description, terms referring to signals, terms referring to channels, terms referring to control information, terms referring to network entities, terms referring to components of a device, etc., are used for convenience of explanation. Therefore, they are not limited to the terms used in the present disclosure, and other terms referring to objects having equivalent technical meaning may be used.

In the following description, physical channel and signal may be used interchangeably with data or control signals. For example, PDSCH (physical downlink shared channel) is a term that refers to a physical channel through which data is transmitted, but PDSCH can also be used to refer to data. That is, in the present disclosure, the expression ‘transmit a physical channel’ can be interpreted equivalently to the expression ‘transmit data or a signal through a physical channel’.

Hereinafter, in the present disclosure, the higher signaling means a signal transmission method in which a base station transmits a signal to a terminal using a downlink (DL) data channel of a physical layer, or a terminal transmits a signal to a base station using an uplink (UL) data channel of a physical layer. The higher signaling can be understood as radio resource control (RRC) signaling or medium access control (MAC) control element (CE).

In addition, in the present disclosure, the expressions ‘greater than’ or ‘less than’ are used to determine whether a specific condition is satisfied or fulfilled, but these are only description for expressing an example and do not exclude the use of ‘equal to or greater than’ or ‘equal to or less than’. A condition described as ‘greater than’ can be replaced with ‘equal to or greater than’, a condition described as ‘less than’ can be replaced with ‘equal to or less than’, and a condition described as ‘equal to or greater than and less than’ can be replaced with ‘greater than and equal to or less than’.

Additionally, the present disclosure describes embodiments using terms used in some communication specifications (e.g., 3rd Generation Partnership Project (3GPP)), but these are only examples for explanation. Embodiments of the present disclosure can be easily modified and applied to other communication systems.

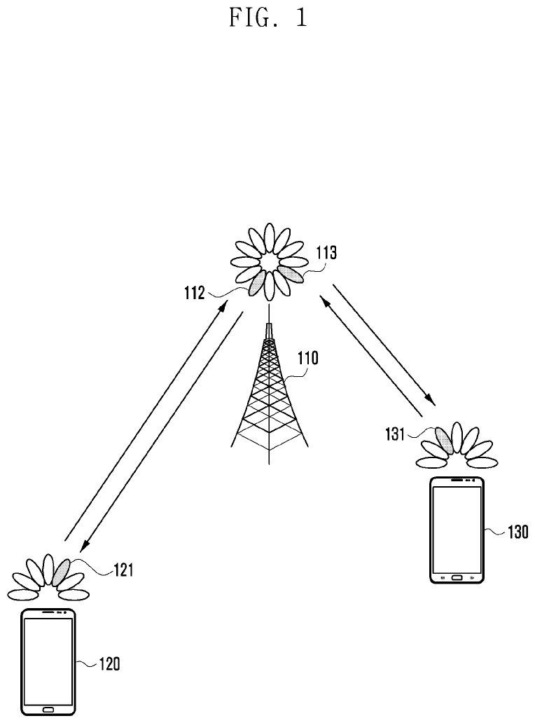

FIG. 1 is a diagram illustrating a wireless communication system according to an embodiment of the present disclosure.

FIG. 1 illustrates a base station 110, a terminal 120, and a terminal 130 as some of the nodes that use wireless channels in the wireless communication system. Although FIG. 1 shows only one base station, other base stations identical or similar to the base station 110 may be further included.

Referring to FIG. 1, the base station 110 is a network infrastructure that provides wireless access to the terminals 120 and 130. The base station 110 has coverage defined as a certain geographic area based on the distance over which signals can be transmitted. The base station 110 may be referred to as ‘access point (AP)’, ‘eNodeB (eNB)’, ‘5th generation node (5G node)’, ‘next generation nodeB (gNB)’, ‘wireless point’, ‘transmission/reception point (TRP)’, or other terms with equivalent technical meaning, in addition to ‘base station’.

Each of the terminal 120 and the terminal 130 is a device used by a user and performs communication with the base station 110 over a wireless channel. The link from the base station 110 to the terminal 120 or the terminal 130 is referred to as a downlink, and the link from the terminal 120 or the terminal 130 to the base station 110 is referred to as an uplink. In some cases, at least one of the terminal 120 and the terminal 130 may be operated without user intervention. That is, at least one of the terminal 120 and the terminal 130 is a device that performs machine type communication (MTC) and may not be carried by the user. Each of the terminal 120 and the terminal 130 may be referred to as a ‘user equipment (UE)’, ‘mobile station’, ‘subscriber station’, ‘remote terminal’, ‘wireless terminal’, or ‘user device’, or other terms with equivalent technical meaning, in addition to ‘terminal’.

The base station 110, the terminal 120, and the terminal 130 may transmit and receive wireless signals in the millimeter wave (mmWave) band (e.g., 28 GHz, 30 GHz, 38 GHz, 60 GHz). In this case, to improve channel gain, the base station 110, the terminal 120, and the terminal 130 may perform beamforming. Here, beamforming may include transmission beamforming and reception beamforming. That is, the base station 110, the terminal 120, and the terminal 130 may impart directionality to the transmission signal or the reception signal. To do so, the base station 110 and the terminals 120 and 130 may select serving beams 112, 113, 121, and 131 through a beam search or beam management procedure. After the serving beams 112, 113, 121, and 131 are selected, subsequent communication may be performed via resources that are in a quasi co-located (QCL) relationship with the resources where the serving beams 112, 113, 121, 131 are transmitted.

A first antenna port and a second antenna port may be evaluated as being in a QCL relationship when the large-scale characteristics of the channel carrying the symbols on the first antenna port can be inferred from the channel carrying the symbols on the second antenna port. For example, the large-scale characteristics may include at least one of delay spread, doppler spread, doppler shift, average gain, average delay, and spatial receiver parameters.

The base station and the terminal are connected through a Uu interface. Uplink refers to a wireless link through which a terminal transmits data or control signals to a base station, and downlink refers to a wireless link through which a base station transmits data or control signals to a terminal.

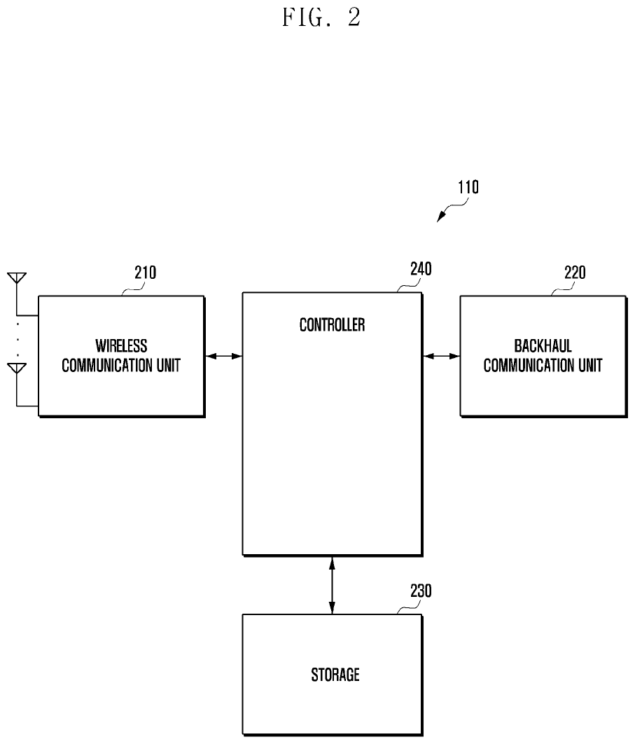

FIG. 2 is a diagram illustrating the constitution of a base station in a wireless communication system according to an embodiment of the present disclosure.

The constitution shown in FIG. 2 can be understood as the constitution of the base station 110. Terms such as ‘ . . . unit’ or ‘ . . . -er/or’ used hereinafter refer to a unit that processes at least one function or operation, which may be implemented through hardware, software, or a combination of hardware and software.

Referring to FIG. 2, the base station 110 includes a wireless communication unit 210, a backhaul communication unit 220, a storage 230, and a controller 240. However, the components of the base station are not limited to the above examples. For example, the base station may include more or fewer components than those described above. In addition, the wireless communication unit 210, the backhaul communication unit 220, the storage 230, and the controller 240 may be implemented in the form of a single chip. Additionally, the controller 240 may include one or more processors.

The wireless communication unit 210 performs functions for transmitting and receiving signals through a wireless channel. For example, the wireless communication unit 210 performs a conversion function between baseband signals and bit strings according to the physical layer specification of the system. For example, when transmitting data, the wireless communication unit 210 generates complex symbols by encoding and modulating the transmitted bit strings. Additionally, when receiving data, the wireless communication unit 210 restores the received bit strings by demodulating and decoding the baseband signals.

Additionally, the wireless communication unit 210 upconverts the baseband signals into radio frequency (RF) band signals and transmits them through an antenna, and down-converts the RF band signals received through the antenna into baseband signals. To this end, the wireless communication unit 210 may include a transmission filter, a reception filter, an amplifier, a mixer, an oscillator, a digital to analog convertor (DAC), an analog to digital convertor (ADC), etc. Additionally, the wireless communication unit 210 may include a plurality of transmission and reception paths. Furthermore, the wireless communication unit 210 may include at least one antenna array constituted by a plurality of antenna elements.

In terms of hardware, the wireless communication unit 210 may be constituted by a digital unit and an analog unit, and the analog unit may be constituted by a plurality of sub-units according to operating power, operating frequency, etc. The digital unit may be implemented with at least one processor (e.g., digital signal processor (DSP)).

The wireless communication unit 210 transmits and receives signals as described above. Accordingly, all or part of the wireless communication unit 210 may be referred to as a ‘transmitter’, ‘receiver’, or ‘transceiver’. Additionally, in the following description, transmission and reception performed through a wireless channel is used to include processing performed by the wireless communication unit 210 as described above.

The backhaul communication unit 220 provides an interface for communicating with other nodes in the network. That is, the backhaul communication unit 220 converts bit strings transmitted from the base station 110 to another node, for example, another access node, another base station, a higher node, a core network, etc., into physical signals, and converts the physical signals received from the other node into bit strings.

The storage 230 stores data such as basic programs, application programs, and configuration information for operation of the base station 110. The storage 230 may be constituted by volatile memory, non-volatile memory, or a combination of volatile memory and non-volatile memory. Also, the storage 230 provides the stored data according to the request of the controller 240.

The controller 240 controls the overall operation of the base station 110. For example, the controller 240 transmits and receives signals through the wireless communication unit 210 or the backhaul communication unit 220. Additionally, the controller 240 records and reads data to/from the storage 230. Additionally, the controller 240 can perform the function of protocol stack required by communication specification. According to another implementation, the protocol stack may be included in the wireless communication unit 210. To this end, the controller 240 may include at least one processor. According to an embodiment, the controller 240 may control the base station 110 to perform operations according to embodiments described later.

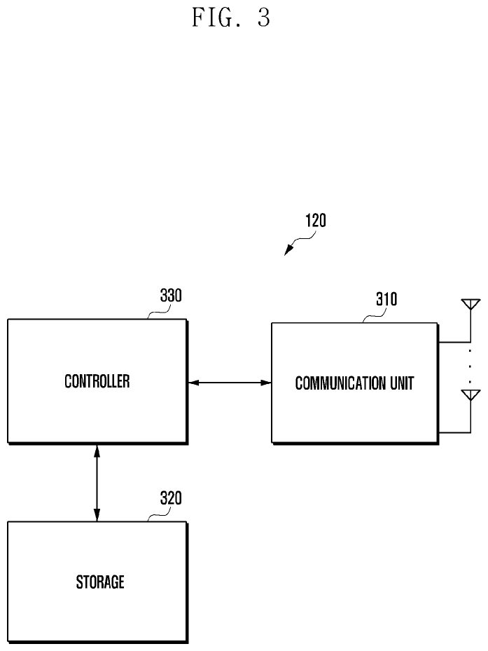

FIG. 3 is a diagram illustrating the constitution of a terminal in the wireless communication system according to an embodiment of the present disclosure.

The constitution shown in FIG. 3 can be understood as the constitution of the terminal 120. Terms such as ‘ . . . unit’ or ‘ . . . -er/or’ used hereinafter refer to a unit that processes at least one function or operation, which may be implemented through hardware, software, or a combination of hardware and software.

Referring to FIG. 3, the terminal 120 includes a communication unit 310, a storage 320, and a controller 330. However, the components of the terminal 120 are not limited to the examples described above. For example, the terminal 120 may include more or fewer components than the components described above. In addition, the communication unit 310, the storage 320, and the controller 330 may be implemented in the form of a single chip. Additionally, the controller 330 may include one or more processors.

The communication unit 310 performs functions for transmitting and receiving signals through a wireless channel. For example, the communication unit 310 performs a conversion function between baseband signals and bit strings according to the physical layer specification of the system. For example, when transmitting data, the communication unit 310 generates complex symbols by encoding and modulating the transmitted bit string. Additionally, when receiving data, the communication unit 310 restores the received bit string by demodulating and decoding the baseband signals. Additionally, the communication unit 310 upconverts the baseband signals into RF band signals and transmits them through an antenna, and down-converts the RF band signals received through the antenna into baseband signals. For example, the communication unit 310 may include a transmission filter, a reception filter, an amplifier, a mixer, an oscillator, a DAC, an ADC, etc.

Additionally, the communication unit 310 may include a plurality of transmission and reception paths. Furthermore, the communication unit 310 may include at least one antenna array constituted by a plurality of antenna elements. In terms of hardware, the communication unit 310 may be constituted by digital circuits and analog circuits (e.g., radio frequency integrated circuit (RFIC)). Here, the digital circuits and analog circuits may be implemented in one package. Additionally, the communication unit 310 may include a plurality of RF chains. Furthermore, the communication unit 310 may perform beamforming.

The communication unit 310 transmits and receives signals as described above. Accordingly, all or part of the communication unit 310 may be referred to as a ‘transmitter’, ‘receiver’, or ‘transceiver’. Additionally, in the following description, transmission and reception performed through a wireless channel are used to include the processing performed by the communication unit 310 as described above.

The storage 320 stores data such as basic programs, application programs, and configuration information for operation of the terminal 120. The storage 320 may be constituted by volatile memory, non-volatile memory, or a combination of volatile memory and non-volatile memory. Also, the storage 320 provides the stored data according to the request of the controller 330.

The controller 330 controls the overall operation of the terminal 120. For example, the controller 330 transmits and receives signals through the communication unit 310. Additionally, the controller 330 records and reads data to/from the storage 320. Also, the controller 330 may perform the function of protocol stack required by communication specification. To this end, the controller 330 may include at least one processor or microprocessor, or may be part of a processor. Additionally, a portion of the communication unit 310 and the controller 330 may be referred to as a communication processor (CP). According to an embodiment, the controller 330 may control the terminal 120 to perform operations according to embodiments described later.

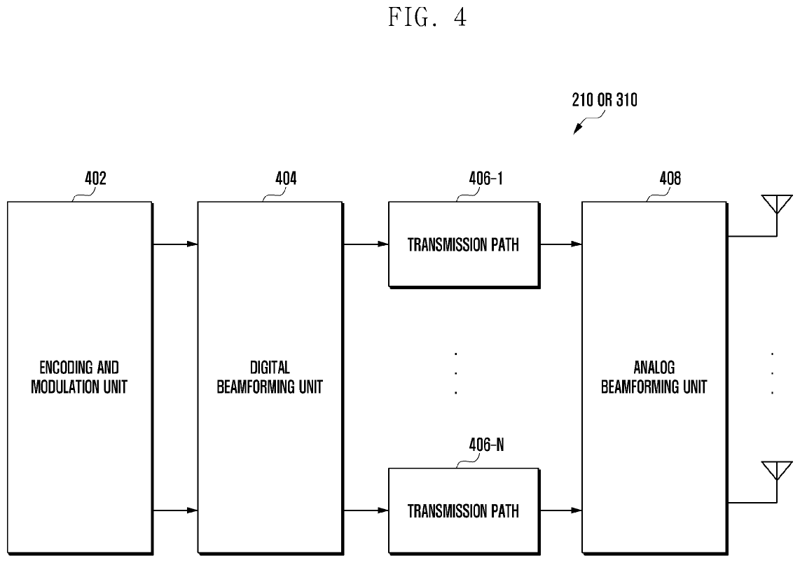

FIG. 4 is a diagram illustrating the constitution of a communication unit in the wireless communication system according to an embodiment of the present disclosure.

FIG. 4 shows an example of the detailed constitution of the wireless communication unit 210 of FIG. 2 or the communication unit 310 of FIG. 3. Particularly, FIG. 4 shows components for performing beamforming as part of the wireless communication unit 210 of FIG. 2 or the communication unit 310 of FIG. 3.

Referring to FIG. 4, the wireless communication unit 210 or communication unit 310 includes an encoding and modulation unit 402, a digital beamforming unit 404, a plurality of transmission paths 406-1 to 406-N, and an analog beamforming unit 408.

The encoding and modulation unit 402 performs channel encoding. For channel encoding, at least one of a low density parity check (LDPC) code, a convolution code, and a polar code may be used. The encoding and modulation unit 402 generates modulation symbols by performing constellation mapping.

The digital beamforming unit 404 performs beamforming on digital signals (e.g., modulation symbols). To this end, the digital beamforming unit 404 multiplies the modulation symbols by beamforming weights. Here, the beamforming weights are used to change the size and phase of the signal, and may be referred to as a ‘precoding matrix’, ‘precoder’, etc. The digital beamforming unit 404 outputs digitally beamformed modulation symbols to the plurality of transmission paths 406-1 to 406-N. At this time, according to the multiple input multiple output (MIMO) transmission technique, the modulation symbols may be multiplexed or the same modulation symbols may be provided to the plurality of transmission paths 406-1 to 406-N.

The plurality of transmission paths 406-1 to 406-N convert digitally beamformed digital signals into analog signals. To this end, each of the plurality of transmission paths 406-1 to 406-N may include an inverse fast fourier transform (IFFT) operation unit, a cyclic prefix (CP) insertion unit, a DAC, and an up-conversion unit. The CP insertion unit, which is for the orthogonal frequency division multiplexing (OFDM) method, may be excluded when another physical layer method (e.g., filter bank multi-carrier (FBMC)) is applied. That is, the plurality of transmission paths 406-1 to 406-N provide an independent signal processing process for a plurality of streams generated through digital beamforming. However, depending on the implementation, some of the components of the plurality of transmission paths 406-1 to 406-N may be commonly used.

The analog beamforming unit 408 performs beamforming on analog signals. To this end, the digital beamforming unit 404 multiplies the analog signals by beamforming weights. Here, the beamforming weights are used to change the size and phase of the signal. Particularly, depending on the connection structure between the plurality of transmission paths 406-1 to 406-N and the antennas, the analog beamforming unit 440 may be configured in various ways. For example, each of the plurality of transmission paths 406-1 to 406-N may be connected to one antenna array. As another example, the plurality of transmission paths 406-1 to 406-N may be connected to one antenna array. As another example, the plurality of transmission paths 406-1 to 406-N may be adaptively connected to one antenna array or to two or more antenna arrays.

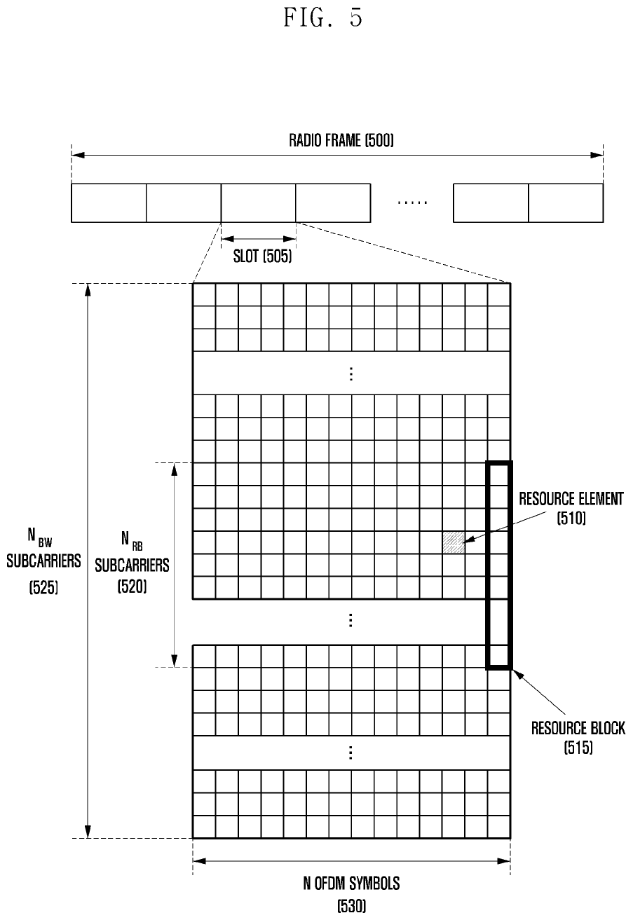

FIG. 5 is a diagram illustrating the structure of wireless time-frequency resources of the wireless communication system according to an embodiment of the present disclosure.

Referring to FIG. 5, in the radio resource area, the horizontal axis represents the time domain and the vertical axis represents the frequency domain. The minimum transmission unit in the time domain is an OFDM symbol or DFT-S-OFDM symbol, where N_{symb} OFDM symbols or DFT-S-OFDM symbols 530 are included in one slot 505. Unlike slots, in the NR system, the length of a subframe may be defined as 1.0 ms, and the length of a radio frame 500 may be defined as 10 ms. The minimum transmission unit in the frequency domain is a subcarrier, and the bandwidth of the entire system transmission band may include a total of N_{BW} subcarriers 525. Specific values such as N_{symb} and N_{BW} may be applied variably depending on the system.

The basic unit of the time-frequency resource area is a resource element (RE) 510, which may be represented as an OFDM symbol index or a DFT-S-OFDM symbol index and a subcarrier index. A resource block (RB) 515 may be defined as N_{RB} consecutive subcarriers 520 in the frequency domain. Generally, the minimum transmission unit of data is an RB unit, and in an NR system, N_{symb}=14, and N_{RB}=12 generally.

The structure of wireless time-frequency resources as shown in FIG. 5 may be applied to the Uu interface.

In the present disclosure, the base station may provide the terminal with random access configuration information that the terminal may use in the random access procedure. The random access configuration information may include at least one of random access preamble, random access time and/or frequency resources, random access resource partitions (RA partitions), or random access prioritization parameters or a combination thereof. For random access preamble, random access time and/or frequency resources, and random access resource partitions, random access parameters used in a two-step (msgA, msgB transmission and reception procedure) random access procedure and/or random access parameters used in a four-step random access procedure may be included. The random access prioritization parameters may include a scaling factor BI parameter or a power ramping step parameter. The base station can provide the terminal with random access configuration information applicable to each function (slice, small data transmission, coverage enhancement, RedCap). For example, the base station may transmit the following information in [Table 1] to indicate to the terminal which functions it provides random access configuration information for. Meanwhile, the present disclosure is not limited to [Table 1] below, and the information in [Table 1] may be referred to by other names.

TABLE 1
FeatureCombination ::= SEQUENCE {

| | |
|---|---|
| redcap ENUMERATED {true} | OPTIONAL, -- Need R |
| smallData ENUMERATED {true} | OPTIONAL, -- Need R |
| sliceGroup SliceGroupList | OPTIONAL, -- Need R |
| covEnh ENUMERATED {true} | OPTIONAL, -- Need R |
| spare4 ENUMERATED {true} | OPTIONAL, -- Need R |
| spare3 ENUMERATED {true} | OPTIONAL, -- Need R |
| spare2 ENUMERATED {true} | OPTIONAL, -- Need R |
| spare1 ENUMERATED {true} | OPTIONAL -- Need R |
| laterThanRel17Features | ENUMERATED {true} OPTIONAL, -- Need R |

...
}
SliceGroupList ::= SEQUENCE (SIZE (1..UpperLimit)) OF SliceGroupID

Referring to [Table 1], when {true} is set for each function, it may indicate that the random access configuration information is applied to the corresponding function. Slice Group List information is a parameter defined for the purpose of indicating whether the slice function is supported. In case that Slice Group List information exists, it may indicate that the random access configuration information is applied to the slice corresponding to each slice group identifier (Slice Group ID). When the base station configures the information in [Table 1] for the terminal, the information may be provided in conjunction with at least one of random access preamble, random access time/frequency resources, and random access resource partition or a combination thereof. Here, the random access preamble, random access time/frequency resources, and random access resource partition may correspond to the random access parameters used in the 2-step (msgA, msgB transmission and reception procedure) random access procedure and/or the random access parameters used in the 4-step random access procedure. When the base station configures the information in [Table 1] for the terminal, the information can be provided in conjunction with random access prioritization parameters (scaling factor BI and/or power ramping step). For example, the random access prioritization parameters may be configured for one or multiple slice groups when a slice group list exists.

For example, the information from the base station including the random access configuration information on each function is shown in [Table 2] below. In [Table 2], AdditionalRACH-ConfigCommon is a random access configuration parameter configured for one or plurality of functions, and this configuration parameter may be used when the terminal performs a random access procedure for one or plurality of functions. Meanwhile, the present disclosure is not limited to [Table 2] below, and the information in [Table 2] may be referred to by other names.

TABLE 2
BWP-UplinkCommon ::= SEQUENCE {

| | |
|---|---|
| genericParameters | BWP, |
| rach-ConfigCommon | SetupRelease { RACH-ConfigCommon } OPTIONAL, -- Need M |
| pusch-ConfigCommon | SetupRelease { PUSCH-ConfigCommon } OPTIONAL, -- Need M |
| pucch-ConfigCommon | SetupRelease { PUCCH-ConfigCommon } OPTIONAL, -- Need M |

```
  ...,
  [[
  rach-ConfigCommonIAB-r16 SetupRelease { RACH-ConfigCommon } OPTIONAL, -- Need M
  useInterlacePUCCH-PUSCH-r16 ENUMERATED {enabled} OPTIONAL, -- Need R
  msgA-ConfigCommon-r16 SetupRelease { MsgA-ConfigCommon-r16 } OPTIONAL -- Cond
SpCellOnly2
  ]],
  [[
```

| enableRA-PrioritizationForSlicing-r17 BOOLEAN | | OPTIONAL, -- Cond RAPrioSliceAI |
|---|---|---|
| additionalRACH-ConfigCommonList | SetupRelease { AdditionalRACH-ConfigCommonList } | |
| rsrp-ThresholdMsg3-r17 | RSRP-Range | OPTIONAL -- Need R |

]]
}
AdditionalRACH-ConfigCommonList ::= SEQUENCE (SIZE(1..maxAdditionalRACH)) OF
AdditionalRACH-ConfigCommon
Additional RACH-ConfigCommon ::= SEQUENCE {

| | | |
|---|---|---|
| rach-ConfigCommon | RACH-ConfigCommon | OPTIONAL, -- Need k |
| msgA-ConfigCommon | MsgA-ConfigCommon-r16 | OPTIONAL, -- Cond R // Configuration |

information used for 2-step random access procedure
...
}
BWP-UplinkCommon
The IE BWP-UplinkCommon is used to configure the common parameters of an uplink BWP. They
are “cell specific” and the network ensures the necessary alignment with corresponding
parameters of other UEs. The common parameters of the initial bandwidth part of the PCell
are also provided via system information. For all other serving cells, the network provides
the common parameters via dedicated signalling.
additionalRACH-ConfigCommonList
List of feature or feature combination-specific RACH configurations, i.e. the RACH
configurations configured in addition to the one configured by rach-ConfigCommon and by
msgA-ConfigCommon.

Referring to [Table 2], the parameter BWP-UplinkCommon may include random access configuration information provided for use by the terminal in a conventional general random access procedure. When the random access configuration information is provided for each function, this random access configuration information may be provided through the parameter AdditionalRACH-ConfigCommon. This parameter AdditionalRACH-ConfigCommon may be applied when performing a random access procedure for the coverage enhancement function, RedCap function, small data transmission function, and/or slice group list, that is, the slice function, which are set to {true} in [Table 1]. The parameter Rach-ConfigCommon may provide parameters applicable when performing a 4-step random access procedure, and the parameter msgA-ConfigCommon may provide parameters applicable when performing a 2-step random access procedure.

[Table 3] and [Table 4] are examples of random access configuration parameters applicable when performing a 4-step random access procedure and random access configuration parameters applicable when performing a 2-step random access procedure, respectively. Meanwhile, the present disclosure is not limited to [Table 3] and [Table 4] below, and the information in [Table 3] and [Table 4] may be referred to by other names.

TABLE 3

| | |
|---|---|
| RACH-ConfigCommon ::= | SEQUENCE { |

```
      rach-ConfigGeneric RACH-ConfigGeneric,
      totalNumberOfRA-Preambles INTEGER (1..63) OPTIONAL, -- Need S
      ssb-perRACH-OccasionAndCB-PreamblesPerSSB CHOICE {
```

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      } OPTIONAL, -- Need M
      groupBconfigured SEQUENCE {
```

| | |
|---|---|
| ra-Msg3SizeGroupA | ENUMERATED {b56, b144, b208, b256, b282, b480, b640, |

b800, b1000, b72, spare6, spare5, spare4, spare3, spare2, spare1},

| | |
|---|---|
| messagePowerOffsetGroupB | ENUMERATED { minusinfinity, dB0, dB5, dB8, dB10, |

```
  dB12, dB15, dB18),
        numberOfRA-PreamblesGroupA INTEGER (1..64)
    } OPTIONAL, -- Need R
    ra-ContentionResolutionTimer ENUMERATED { sf8, sf16, sf24, sf32, sf40, sf48, sf56,
sf64},
    rsrp-ThresholdSSB RSRP-Range OPTIONAL, -- Need R
    rsrp-ThresholdSSB-SUL RSRP-Range OPTIONAL, -- Cond SUL
    prach-RootSequenceIndex CHOICE {
```

| | |
|---|---|
| 1839 | INTEGER (0..837), |
| 1139 | INTEGER (0..137) |

},

| | |
|---|---|
| msg1-SubcarrierSpacing | SubcarrierSpacing OPTIONAL, -- Cond L139 |

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} OPTIONAL, -- Need R |

```
    ...,
    [[
    ra-PrioritizationForAccessIdentity-r16 SEQUENCE {
```

| | |
|---|---|
| ra-Prioritization-r16 | RA-Prioritization, |
| ra-PrioritizationForAI-r16 | BIT STRING (SIZE (2)) |

} OPTIONAL, -- Cond InitialBWP-Only

| | |
|---|---|
| prach-RootSequenceIndex-r16 | CHOICE { |
| 1571 | INTEGER (0..569), |
| 11151 | INTEGER (0..1149) |

```
      } OPTIONAL -- Need R
      ]],
  [[
```

| | |
|---|---|
| ra-PrioritizationForSlicing RA-PrioritizationForSlicing | OPTIONAL, -- Cond |

InitialBWP-Only

| | |
|---|---|
| featureCombinationPreamblesList | SEQUENCE |
| (SIZE(1..maxFeatureCombPreamblesPerRACHResource)) OF | FeatureCombinationPreambles |

```
  OPTIONAL -- Need R
      ]]
```

```
TABLE 4
.
  - MsgA-ConfigCommon
  The IE MsgA-ConfigCommon is used to configure the PRACH and PUSCH resource for transmission
  of MsgA in 2-step random access type procedure.
```

| | |
|---|---|
| MsgA-ConfigCommon-r16 ::= | SEQUENCE { |
| rach-ConfigCommonTwoStepRA-r16 | RACH-ConfigCommonTwoStepRA-r16, |

| | |
|---|---|
| msgA-PUSCH-Config-r16 | MsgA-PUSCH-Config-r16 |

```
  OPTIONAL --Cond InitialBWPConfig
  }
  - RACH-ConfigCommonTwoStepRA
  The IE RACH-ConfigCommonTwoStepRA is used to specify cell specific 2-step random-access
  type parameters. RACH-ConfigCommonTwoStepRA may configure information on the functions or the
  combination of functions including slices that can use the cell specific 2-step random
  access type parameters.
    [[
```

| | |
|---|---|
| ra-PrioritizationForSlicingTwoStep | RA-PrioritizationForSlicing |

OPTIONAL, -- Cond InitialBWP-Only

| | |
|---|---|
| featureCombinationPreamblesList | SEQUENCE |
| (SIZE(1..maxFeatureCombPreamblesPerRACHResource)) OF | FeatureCombinationPreambles |

```
  OPTIONAL -- Need R
      ]]
```

[Table 5] is an example of random access preamble parameters configured for use by the terminal when performing a function-specific random access procedure. Meanwhile, the present disclosure is not limited to [Table 5] below, and the information in [Table 5] may be referred to by other names.

TABLE 5
FeatureCombinationPreambles
The IE FeatureCombinationPreambles associates a set of preambles with a feature combination.
For parameters which can be provided in this IE and also in RACH-ConfigCommon or
MsgA-ConfigCommon: if a parameter provided in this IE is signalled, the UE applies this field
value when performing Random Access using a preamble in this featureCombinationPreambles,
otherwise the UE applies the corresponding value signalled in RACH-ConfigCommon or
MsgA-ConfigCommon.)
FeatureCombinationPreambles ::= SEQUENCE {

| | |
|---|---|
| featureCombination | FeatureCombination, |
| startPreambleForThisPartition | INTEGER (1..64), |
| numberOfPreamblesForThisPartition | INTEGER (1..64), |
| ssb-SharedRO-MaskIndex | INTEGER (1..15) OPTIONAL, -- Need R |
| numberOfRA-PreamblesGroupA | INTEGER (1..64) OPTIONAL, -- Need R |
| separateMsgA-PUSCH-Config | MsgA-PUSCH-Config-r16 OPTIONAL, -- Cond |

MsgAConfigCommon

| msgA-RSRP-Threshold | RSRP-Range | OPTIONAL, -- Need |
|---|---|---|
| featureSpecificParameters | SEQUENCE { | |
| rsrp-ThresholdSSB | RSRP-Range | OPTIONAL, -- Need R. |

| | |
|---|---|
| messagePowerOffsetGroupB | ENUMERATED { minusinfinity, dB0, dB5, dB8, dB10, |

dB12, dB15, dB18} OPTIONAL, -- Need R

| | |
|---|---|
| ra-SizeGroupA | ENUMERATED {b56, b144, b208, b256, b282, b480, |

b640, b800, b1000, b72, spare6, spare5, spare4, spare3, spare2, spare1} OPTIONAL, -
- Need R

| | |
|---|---|
| deltaPreamble | INTEGER (−1..6) OPTIONAL -- Need R |

}
}

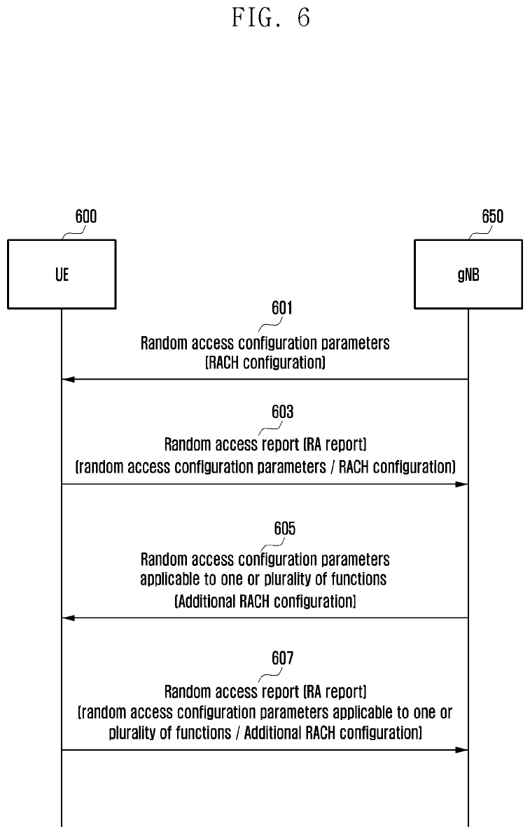

Hereinafter, with reference to FIGS. 6 to 10, the operation of the terminal and the base station to process the terminal's report about random access for one or plurality of functions will be described. The random access procedure for one or plurality of functions may be performed using random access configuration parameters including the information in [Table 1] to [Table 5] configured to the terminal for one or plurality of functions. When the terminal performs the random access procedure using random access configuration parameters including the information in [Table 1] to [Table 5] configured for one or plurality of functions, the terminal may store the random access configuration parameter information on one or plurality of functions that was used when the random access procedure succeeded for one or plurality of functions. In case that the terminal is configured to report the random access configuration parameters that were used when the random access procedure succeeded for the one or plurality of functions, it may transmit a random access report to the base station that includes the corresponding random access configuration parameters. When the terminal performs a random access procedure using random access configuration parameters including the information in [Table 1] to [Table 5] configured for one or plurality of functions, the terminal may store random access configuration parameter information for the one or plurality of functions that was used when the random access procedure failed for the one or plurality of functions. In case that the terminal is configured to report the random access configuration parameters that were used when the random access procedure fails for the one or plurality of functions, it may transmit a random access report to the base station that includes the corresponding random access configuration parameters. Additionally, since the terminal may have used a 2-step random access procedure or may use a 4-step random access procedure, the terminal may report the random access configuration parameters corresponding to the 2-step random access procedure or 4-step random access procedure it used. The random access configuration parameters for one or plurality of functions may be configured as common information shared and used by all terminals and used in a contention-based random access procedure, or may be configured as dedicated information used only by specific terminals and used in a contention-free random access procedure. The terminal may transmit to the base station a random access report about a case where it performed a contention-based random access procedure for one or plurality of functions, and may transmit to the base station a random access report about a case where it performed a contention-free (non-contention) random access procedure for one or plurality of functions.

FIG. 6 is a diagram illustrating signal flows between a terminal and a base station performing random access reporting for a function according to an embodiment of the present disclosure.

Referring to FIG. 6, at step 601, the terminal 600 may acquire random access configuration parameters that may be used to perform a general random access procedure from the base station 650.

At step 603, the terminal 600 may perform a random access procedure using the random access configuration parameters of step 601, and may transmit a random access report to the base station 650 including the random access configuration parameters used when the random access procedure was performed. In the case of the random access reporting performed by the terminal 600 at step 603, the terminal 600 may be configured to perform the random access reporting by including the random access configuration parameters used when the random access procedure was successfully performed, or the terminal 600 may be configured to perform the random access reporting by including the random access configuration parameters used when the terminal 600 fails the random access procedure.

An event in which the terminal 600 performs a random access procedure may include, for example, at least one of accessing the system after cell selection/reselection, determining that the beam usage has failed because the beam used by the terminal for data transmission and reception with the base station is not suitable and restoring the beam, the terminal performing a handover (normal handover, conditional handover, etc.) from a serving cell to a target cell, the terminal performing a secondary cell group configuration, the terminal synchronizing an uplink to the base station, the terminal requesting uplink resources from the base station, the terminal requesting system information from the base station, or any combination thereof. Meanwhile, the present disclosure is not limited thereto.

For each event, the terminal may store the random access configuration parameters used in the terminal's random access procedure. This information may correspond to information to be included when the terminal performs random access reporting, and this information may be stored in the terminal for a determined time and the terminal may be configured to delete it if not used within that time.

The random access report transmitted from the terminal 600 to the base station 650 may include information (e.g., RA Purpose parameter) indicating which event the terminal 600 is reporting about the performed random access procedure. The random access report transmitted from the terminal 600 to the base station 650 may include [Table 6] as an example. Meanwhile, the present disclosure is not limited to [Table 6] below, and the information in [Table 6] may be referred to by other names.

TABLE 6

| | |
|---|---|
| RA-Report-r16 ::= | SEQUENCE { |

| | |
|---|---|
| cellId-r16 | CHOICE { |

| | |
|---|---|
| cellGlobalId-r16 | CGI-Info-Logging-r16, |
| pci-arfcn-r16 | SEQUENCE { |

| | |
|---|---|
| physCellId-r16 | PhysCellId, |
| carrierFreq-r16 | ARFCN-ValueNR |

```
    }
  },
  ra-InformationCommon-r16 RA-InformationCommon-r16 OPTIONAL,
```

| | | | |
|---|---|---|---|
| raPurpose-r16 | ENUMERATED | {accessRelated, | beamFailureRecovery, |

| | | |
|---|---|---|
| reconfigurationWithSync, | ulUnSynchronized, | schedulingRequestFailure, |

```
noPUCCHResourceAvailable, requestForOtherSI, msg3RequestForOtherSI-r17, spare8,
spare7, spare6, spare5, spare4, spare3, spare2, spare1},
  ...,
  [[
```

| | | |
|---|---|---|
| spCellID-r17 | CGI-Info-Logging-r16 | OPTIONAL |

]]

At step 605, the terminal 600 may acquire from the base station 650 the random access configuration parameters applicable to one or plurality of functions. When performing a random access procedure for one or plurality of functions that are configured to be used, the terminal 600 may perform the random access procedure using the random access configuration parameters acquired at step 605.

At step 607, the terminal 600 may transmit to the base station 650 a random access report about the random access procedure for one or plurality of functions performed by the terminal 600. The random access report transmitted by the terminal 600 to the base station 650 may include at least one of information on one or plurality of functions performed by the terminal 600 and information on the random access configuration parameters applied to the corresponding functions, or a combination thereof. In the case of a random access report for one or plurality of functions performed by the terminal 600 at step 607, the terminal 600 may be configured to perform the random access reporting by including the random access configuration parameters used when the random access procedure is successfully performed by the terminal 600, or the terminal 600 may be configured to perform the random access reporting by including the random access configuration parameters used when the terminal 600 fails the random access procedure.

An event in which the terminal 600 performs a random access procedure for one or plurality of functions may include, for example, at least one of accessing the system after cell selection/reselection, determining that the beam usage has failed because the beam used by the terminal for data transmission and reception with the base station is not suitable and restoring the beam, the terminal performing a handover (normal handover, conditional handover, etc.) from a serving cell to a target cell, the terminal performing a secondary cell group configuration, the terminal synchronizing an uplink to the base station, the terminal requesting uplink resources from the base station, the terminal requesting system information from the base station, or any combination thereof. Meanwhile, the present disclosure is not limited thereto.

For each event, the terminal may store the random access configuration parameters used in the terminal's random access procedure. This information may correspond to information to be included when the terminal performs random access reporting, and this information may be stored in the terminal for a determined time and the terminal may be configured to delete it if not used within that time.

The random access report transmitted from the terminal 600 to the base station 650 may include information (e.g., RA Purpose parameter) indicating which event the terminal 600 is reporting about the performed random access procedure. The random access report transmitted from the terminal 600 to the base station 650 at step 607 may include [Table 7] as an example. Meanwhile, the present disclosure is not limited to [Table 7] below, and the information in [Table 7] may be referred to by other names.

TABLE 7
RA-Report-r16 ::= SEQUENCE {

| | |
|---|---|
| cellId-r16 | CHOICE { |

| | |
|---|---|
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
    }
  },
  ra-InformationCommon-r16 RA-InformationCommon-r16 OPTIONAL,
```

| | | | |
|---|---|---|---|
| raPurpose-r16 | ENUMERATED | {accessRelated, | beamFailureRecovery, |

| | | |
|---|---|---|
| reconfigurationWithSync, | ulUnSynchronized, | schedulingRequestFailure, |

```
noPUCCHResourceAvailable, requestForOtherSI, msg3RequestForOtherSI-r17, spare8,
spare7, spare6, spare5, spare4, spare3, spare2, spare1},
  ...,
  [[
```

| | | |
|---|---|---|
| spCellID-r17 | CGI-Info-Logging-r16 | OPTIONAL |

```
  ]]
  [[
  featureCombinationForRA FeatureCombination
  ]]
}
```

When the base station 650 configures the random access configuration parameters that the terminal 600 uses when performing the random access procedure for one or plurality of functions, the base station 650 may configure separate random access configuration parameters for the one or plurality of functions or may configure general random access configuration parameters to be applied to the one or plurality of functions as well. The terminal 600 may perform the random access procedure using the random access configuration parameters (configured separately for a specific function or configured generically) configured by the base station 650 for one or plurality of functions, and may include the random access configuration parameters (configured separately for a specific function or configured generically) used for the one or plurality of functions in the random access report when transmitting the random access report to the base station 650. That is, the random access configuration parameters included in the random access report in [Table 7] are either random access configuration parameters configured separately for a specific function or random access configuration parameters configured to be used in general.

Meanwhile, when the terminal 600 transmits to the base station 650 a random access report for one or plurality of functions, the terminal operation of processing information on the one or plurality of functions included in the random access report is explained in the following embodiments.

(1) The terminal may perform a random access procedure in order to access the system to support small data transmission, RedCap, and coverage enhancement functions and to receive services for these functions. In case that the terminal determines that the random access configuration parameters applicable to one or plurality of functions configured by the base station support a combination of small data transmission and RedCap, the terminal may perform a random access procedure using the corresponding random access configuration parameters. Here, it is assumed that the random access configuration parameters that can support the combination of small data transmission, RedCap, and coverage enhancement intended by the terminal are not configured. The terminal may transmit to the base station a random access report by including information on the combination of functions that it intended when performing the random access procedure, i.e., small data transmission, RedCap, and coverage enhancement (applicable feature information), and information on the combination of functions configured in the random access configuration parameters that were used when performing the actual random access procedure, in this case small data transmission and RedCap.

(2) The terminal may perform a random access procedure in order to access the system to support small data transmission, RedCap, and coverage enhancement functions and to receive services for these functions. In case that the terminal determines that the random access configuration parameters applicable to one or plurality of functions configured by the base station support a combination of small data transmission, RedCap, and coverage enhancement, the terminal may perform a random access procedure using the corresponding random access configuration parameters. Here, it is assumed that the random access configuration parameters that can support the combination of small data transmission, RedCap, and coverage enhancement intended by the terminal are configured. The terminal may transmit to the base station a random access report by including information on the combination of functions that it intended when performing the random access procedure, i.e., small data transmission, RedCap, and coverage enhancement (applicable feature information), and information on the combination of functions configured in the random access configuration parameters that were used when performing the actual random access procedure, in this case small data transmission, RedCap, and coverage enhancement.

(3) As another embodiment of (2), since a combination of all functions intended by the terminal is supported in the random access configuration parameters configured by the base station, the terminal may omit information on the combination of the functions intended by the terminal (applicable feature information), and may configure and transmit to the base station a random access report by including information on the combination of functions configured in the random access configuration parameters that were used when performing the actual random access procedure.

Cases in which the terminal 600 may perform the random access reporting for one or plurality of functions may include examples in the following [Table 8]. The terminal 600 may perform the random access reporting for one or plurality of functions for one or a combination of scenarios included in [Table 8]. Meanwhile, the present disclosure is not limited to [Table 8] below.

TABLE 8
in case that the Cell Selection or Cell Reselection Random Access
configuration parameters are configured for one or plurality of functions
in case that the random access configuration parameters for
reconfigurationWithSync in spCellConfig of MCG, handover, conditional
handover are configured for one or plurality of functions
in case that a use record of random access configuration parameters for
one or plurality of functions may be included in the connection
establishment failure report, when using the random access configuration
parameters for one or plurality of functions
in case that a use record of random access configuration parameters for
one or plurality of functions may be included in the radio link failure
report, when using the random access configuration parameters for one
or plurality of functions
in case that a use record of random access configuration parameters for
one or plurality of functions may be included in the success handover
report, when using the random access configuration parameters for one
or plurality of functions
in case that a use record of random access configuration parameters for
one or plurality of functions may be included in the secondary cell group
failure information report, when the random access configuration
parameters of one or plurality of functions are used in the secondary
cell group configuration procedure

In one embodiment, the information that the terminal 600 configures when the terminal 600 performs random access reporting to the base station 650 for one or plurality of functions may include the example in [Table 9]. [Table 9] is an example of including random access report in the terminal's Connection Establishment Failure Report. However, the present disclosure is not limited to [Table 9] below, and the information in [Table 9] may be referred to by other names.

TABLE 9

| | |
|---|---|
| ConnEstFailReport-r16 ::= | SEQUENCE { |
| measResultFailedCell-r16 | MeasResultFailedCell-r16, |

| | |
|---|---|
| locationInfo-r16 LocationInfo-r16 | OPTIONAL, |

| | |
|---|---|
| measResultNeighCells-r16 | SEQUENCE { |

| | |
|---|---|
| measResultNeighCellListNR MeasResultList2NR-r16 | OPTIONAL, |
| measResultNeighCellListEUTRA MeasResultList2EUTRA-r16 | OPTIONAL |

```
  },
  numberOfConnFail-r16 INTEGER (1..8),
```

| | |
|---|---|
| perRAInfoList-r16 | PerRAInfoList-r16, |
| timeSinceFailure-r16 | TimeSinceFailure-r16, |

...
}
PerRAInfoList-r16 ::= SEQUENCE (SIZE (1..200)) OF PerRAInfo-r16

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

| | |
|---|---|
| featureCombinationForRA | FeatureCombination |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16, |

| | |
|---|---|
| featureCombinationForRA | FeatureCombination |

}
PerRAAttemptInfoList-r16 ::= SEQUENCE (SIZE (1..200)) OF PerRAAttemptInfo-r16

| PerRAAttemptInfo-r16 ::= | SEQUENCE { | |
|---|---|---|
| contentionDetected-r16 | BOOLEAN | OPTIONAL, |
| dIRSRPAboveThreshold-r16 | BOOLEAN | OPTIONAL, |

```
  ...,
  [[
```

| | |
|---|---|
| fallbackToFourStepRA-r17 ENUMERATED {true} | OPTIONAL |

]]
}

In the example of [Table 9], when the terminal that experienced connection establishment failure performs a random access procedure using the random access configuration parameters for one or plurality of functions while reporting the connection establishment failure to the base station, the terminal may report to the base station information on the combination of one or plurality of functions used by the terminal and at least one or a combination of the random access configuration parameters that were used by the terminal for the combination of one or plurality of functions. [Table 9] is an embodiment in which the random access report for the combination of one or plurality of functions is included in the parameter PerRASSBInfo or the parameter perRAInfoList. Although not shown in [Table 9], parameters corresponding to the random access report for the combination of one or plurality of functions may be configured to be included as separate parameters in ConnEstFailReport.

As another embodiment, in the case where the terminal reports Secondary Cell Group Failure Information to the base station, if the terminal has performed a random access procedure on the cells of the secondary cell group using the random access configuration parameters for one or plurality of functions, the terminal may include the random access report about one or plurality of functions in the random access report about Secondary Cell Group Failure Information. [Table 10] is an example of the configuration information on the Secondary Cell Group Failure Information report when it includes a random access report about one or plurality of functions. Meanwhile, the present disclosure is not limited to [Table 10] below, and the information in [Table 10] may be referred to by other names.

TABLE 10
SCGFailureInformation-IEs ::= SEQUENCE {

| | | |
|---|---|---|
| failureReportSCG | FailureReportSCG | OPTIONAL, |

| | | |
|---|---|---|
| nonCriticalExtension | SCGFailureInformation-v1590-IEs | OPTIONAL |

```
}
FailureReportSCG ::= SEQUENCE {
  failureType ENUMERATED {t310-Expiry, randomAccessProblem, rlc-MaxNumRetx,
synchReconfigFailureSCG, scg-ReconfigFailure, srb3-IntegrityFailure, other-r16,
spare1},
  measResultFreqList MeasResultFreqList OPTIONAL,
  measResultSCG-Failure OCTET STRING (CONTAINING MeasResultSCG-Failure)
OPTIONAL,
    ...,
    [[
```

| | |
|---|---|
| locationInfo-r16 LocationInfo-r16 | OPTIONAL, |

```
  failureType-v1610 ENUMERATED {scg-lbtFailure-r16, beamFailureRecoveryFailure-r16,
t312-Expiry-r16, bh-RLF-r16, beamFailure-r17, spare3, spare2, spare1} OPTIONAL
    ]],
    [[
```

| | |
|---|---|
| previousPSCellId-r17 | SEQUENCE { |
| physCellId-r17 | PhysCellId, |
| carrierFreq-r17 | ARFCN-ValueNR |

} OPTIONAL,

| failedPSCellId-r17 | SEQUENCE { | |
|---|---|---|
| physCellId-r17 | PhysCellId, | |
| carrierFreq-r17 | ARFCN-ValueNR | |
| } | | OPTIONAL, |
| timeSCGFailure-r17 | INTEGER (0..1023) | OPTIONAL, |
| perRAInfoList-r17 | PerRAInfoList-r16 | OPTIONAL |

```
    ]],
    [[
        failureType-new ENUMERATED {featurecombinationRAproblem, ...} OPTIONAL
      ]]
}
```

When the terminal performs a random access report about a random access procedure that was performed for one or plurality of functions using the Secondary Cell Group Failure Information in [Table 10], the terminal may set the failureType to randomAccessProblem. As another embodiment, a separate failureType (e.g., feature combination RA problem) that can indicate randomAccessProblem for one or plurality of functions may be defined, and the terminal may include the new failureType when performing random access reporting about the random access procedure that was performed for one or plurality of functions. Additionally, when configuring the random access report for one or plurality of functions, the terminal may include random access configuration parameter information that was used in the random access procedure for one or plurality of functions in the parameter PerRAInfoList. Here, the parameter PerRAInfoList may include a parameter notifying combination information on one or plurality of functions, such as the parameter PerRAInfoList in [Table 9].

As another embodiment, when the terminal experiences a radio link failure (RLF) and transmits a report about the radio link failure (RLF) to the base station, the terminal may include information that it has performed a random access procedure. When the terminal has performed a random access procedure for one or plurality of functions and transmits a random access report for this to the base station, the terminal may use the format shown in [Table 11] below. Meanwhile, the present disclosure is not limited to [Table 11] below, and the information in [Table 11] may be referred to by other names.

TABLE 11

| | |
|---|---|
| RLF-Report-r16 ::= | CHOICE { |
| nr-RLF-Report-r16 | SEQUENCE { |

...

| | |
|---|---|
| connectionFailureType-r16 | ENUMERATED {rlf, hof}, |

```
    rlf-Cause-r16 ENUMERATED {t310-Expiry, randomAccessProblem, rlc-MaxNumRetx,
beamFailureRecoveryFailure, lbtFailure-r16, bh-rlfRecoveryFailure, t312-expiry-r17,
spare1},
    locationInfo-r16 LocationInfo-r16 OPTIONAL,
```

| noSuitableCellFound-r16 | ENUMERATED {true} OPTIONAL, | |
|---|---|---|
| ra-InformationCommon-r16 | RA-InformationCommon-r16 | OPTIONAL, |

```
    ...,
  },
}
```

The parameter RA-InformationCommon in [Table 11] may include a parameter notifying combination information on one or plurality of functions, such as the parameter PerRAInfoList in [Table 9].

As another embodiment, when the terminal transmits a success handover report to the base station, the terminal may include information that it has performed a random access procedure. When the terminal has performed a random access procedure for one or plurality of functions and transmits a random access report for this to the base station, the terminal may use the format shown in [Table 12] below. Meanwhile, the present disclosure is not limited to [Table 12] below, and the information in [Table 12] may be referred to by other names.

TABLE 12

| | |
|---|---|
| SuccessHO-Report-r17 ::= | SEQUENCE { |

...

| | | |
|---|---|---|
| shr-Cause-r17 | SHR-Cause-r17 | OPTIONAL, |

| | |
|---|---|
| ra-InformationCommon-r17 | RA-InformationCommon-r16 |

OPTIONAL,
...
}

The parameter RA-InformationCommon in [Table 12] may include a parameter notifying combination information on one or plurality of functions, such as the parameter PerRAInfoList in [Table 9].

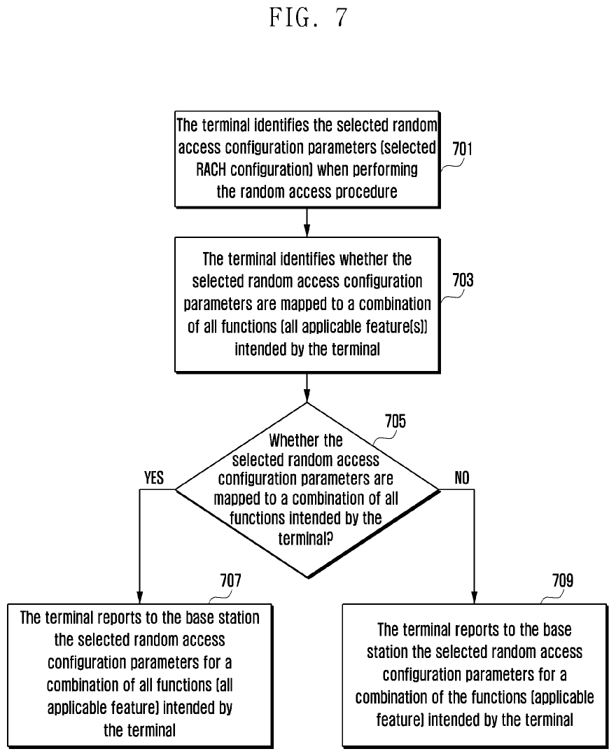

Hereinafter, an operation in which a terminal performs a random access procedure for one or plurality of functions and transmits a report about random access to the base station according to the embodiments of [Table 1] to [Table 12] will be described with reference to FIG. 7.

FIG. 7 is a diagram illustrating an operation of a terminal performing random access reporting about various functions according to various embodiments of the present disclosure.

Referring to FIG. 7, a terminal may perform a random access procedure for one or plurality of functions, and when the terminal determines that the random access configuration parameters are configured for one or plurality of functions, the terminal may perform the random access procedure for the combination of intended functions (one or plurality of functions). The terminal may store the random access configuration parameters that were used when the random access procedure was performed for the combination of intended functions (one or plurality of functions). When the terminal determines that an event for which random access reporting is performed has occurred (e.g., [Table 8]), the terminal may, at step 701, identify the random access configuration parameters that were applied when performing the random access procedure for the combination of intended functions (one or plurality of functions).

At step 703, the terminal may identify whether the random access configuration parameters identified at step 701 have been applied to all functions belonging to the combination of functions (one or plurality of functions) intended by the terminal.

When the terminal determines at step 705 that all functions belonging to the combination of intended functions (one or plurality of functions) are applicable, the terminal may transmit a random access report to the base station at step 707 including information on the random access configuration parameters that the terminal applied to the combination of all functions (one or plurality of functions) intended by the terminal. As an example, the random access report at step 707 may be configured to include information on the combination of functions (applicable feature) and information on the combination of functions configured in the random access configuration parameters that were used when the random access procedure was performed. As another example, the random access report at step 707 may be configured to omit information on the combination of functions (applicable feature) and including information on the functions configured in the random access configuration parameters that were used when the random access procedure was performed.

When the terminal determines at step 705 that the selected random access configuration parameters cannot be applied to all functions belonging to the combination of intended functions (one or plurality of functions), the terminal may transmit a random access report to the base station at step 709 including information on the random access configuration parameters that the terminal has applied to the combination of functions (one or plurality of functions) intended by the terminal. As an example, the information in the random access report at step 709 may be configured to include information on the combination of functions (applicable feature) and information on the combination of functions configured in the random access configuration parameters that were used when performing the actual random access procedure.

When a priority is configured for one or plurality of functions in the random access configuration parameters configured by the base station, the terminal may include the priority information configured for the corresponding functions when performing a random access procedure for one or plurality of functions in the random access report. Priority configurations for one or plurality of functions in the random access configuration parameters, may include examples in the following [Table 13]. Meanwhile, the present disclosure is not limited to [Table 13] below, and the information in [Table 13] may be referred to by other names.

TABLE 13

| SIB1-v1700-IEs ::= | SEQUENCE { |
|---|---|
| ... | |
| featurePriorities | SEQUENCE { |
| redCapPriority FeaturePriority OPTIONAL, | |
| slicingPriority FeaturePriority OPTIONAL, | |
| ce-Priority | FeaturePriority OPTIONAL, |
| sdt-Priority | FeaturePriority OPTIONAL, |

```
  ...
  } OPTIONAL, -- Need R
}
FeaturePriority ::= INTEGER(0..15)
```

featurePriorities
Indicates priorities for features, such as RedCap, Slicing, etc. These
priorities are used to determine which FeatureCombinationPreambles the
UE shall use when a feature maps to more than one
FeatureCombinationPreambles. A lower value means a higher priority.
The network does not signal the same priority for more than one feature.
The network signals a priority for all feature that map to at least one
FeatureCombinationPreambles.)

Upon acquiring information on the random access report from the terminal at steps 707 through 709, the base station may know the information on the combination of functions (one or plurality of functions) intended by the terminal accessing its cell and the information on the combination of functions (one or plurality of functions) corresponding to the random access configuration parameters that were available to the terminal when it accessed the cell. The base station may use this information to configure and provide to the terminal the random access configuration parameters for a combination of functions not previously provided to the terminal but intended by the terminal. Alternatively, the base station may use this information to adjust (e.g., delete or modify) the random access configuration parameters for the combination of functions previously provided to the terminal but not being used and provide them to the terminal. Alternatively, the base station may use this information to adjust (e.g., modify) the random access configuration parameters for the combination of functions previously provided to the terminal and provide them to the terminal.

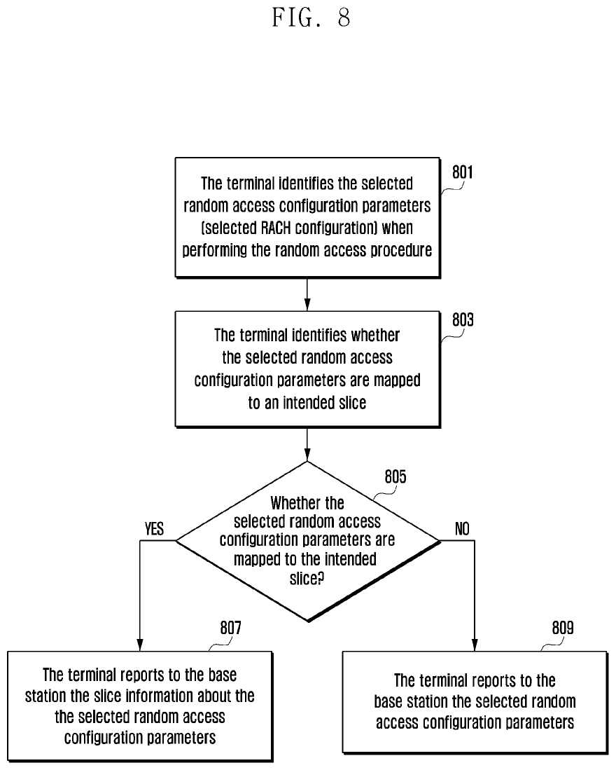

Meanwhile, in the case of a slice function among one or plurality of functions, the base station may group one or plurality of slices into a slice group and operate random access configuration parameters for each slice group. For example, slice group 1 may consist of {slice A, slice B} and slice group 2 may consist of {slice B}. The base station can configure random access configuration parameters for slice group 1 and slice group 2, and may configure each slice group to use general random access configuration parameters or function-specific random access configuration parameters. When performing a random access procedure for a slice function, the terminal may perform the random access procedure by selecting the random access configuration parameters configured for the slice group to which the slice intended by the terminal belongs. In case that the terminal determines that random access report is configured for one or plurality of functions and the one or plurality of functions include slices, the terminal may store the random access configuration parameters that were used when the random access procedure was performed for the slice group, and when the random access reporting event has occurred (e.g., [Table 8]), may transmit a random access report to the base station including the slice group information and the random access configuration parameters for the slice group. Next, an operation of a terminal performing random access reporting for a slice function will be described with reference to FIG. 8.

FIG. 8 is a diagram illustrating an operation of a terminal performing random access reporting for a network slice function according to various embodiments of the present disclosure.

In FIG. 8, it is expressed as a slice, but it can be applied to both the case of operating the random access configuration parameters based on a slice and the case of operating the random access configuration parameters based on a slice group.

Referring to FIG. 8, the terminal may be configured with random access configuration parameters that can be used when the terminal is configured to perform the slice function and performs a random access procedure for the slice function. Random access configuration parameters (RACH configuration) can be configured for one or plurality of slices. The terminal may perform a random access procedure using the random access configuration parameters configured for the intended slice (or slice group). The terminal may store the random access configuration parameters that were used for the intended slice. The terminal may be configured to include the intended slice information in the random access report, when the terminal performs a random access procedure using the random access configuration parameters for the intended slice. When the terminal determines that an event for which random access reporting is performed has occurred (e.g., [Table 8]), the terminal may identify the information on random access configuration parameters selected when performing random access at step 801. At step 803, the terminal may identify whether the selected random access configuration parameters are configured to be used in the intended slice. In the case that the terminal determines at step 805 that the selected random access configuration parameters have been used in the intended slice, the terminal may configure random access report information to include the intended slice information and the used random access configuration parameters and transmit it to the base station at step 807. In the case that the terminal determines at step 805 that the selected random access configuration parameters have not been used in the intended slice, the terminal may configure random access report information to include the used random access configuration parameters and transmit it to the base station at step 809.

For example, when the terminal performs random access reporting for a slice, the random access report configured by the terminal may include examples of [Table 14] or [Table 15]. The random access report from the terminal may include featureCombinationForRA indicating a combination of one or plurality of functions, and sliceGroup information indicating a slice (or slice group) when using the slice function. Meanwhile, the present disclosure is not limited to [Table 14] and [Table 15] below, and the information in [Table 14] and [Table 15] may be referred to by other names.

TABLE 14

| NSAG : NetworkSliceASGroup | |
|---|---|
| RA-Report-r16 ::= | SEQUENCE { |

```
  [[
  featureCombinationForRA FeatureCombination,
  sliceGroup(NSAG) list of slice groups(NSAGs)
  ]]
}
```

TABLE 15
NSAG : NetworkSliceASGroup

| | |
|---|---|
| PerRASSBInfo-r16 ::= | SEQUENCE { |

| | |
|---|---|
| ssb-Index-r16 | SSB-Index, |

| | |
|---|---|
| numberOfPreamblesSentOnSSB-r16 | INTEGER(1..200), |
| PerRAAttemptInfoList-r16 | PerRAAttemptInfoList-r16, |

featureCombinationForRA FeatureCombination,

| | |
|---|---|
| sliceGroup(NSAG) | list of slice groups(NSAGs) |

}

Once the base station acquired the random access report of the terminal, the base station may identify the slice information intended by the terminal trying to access its cell and may identify the random access configuration parameter information applied by the terminal to the slice. In the case that the base station has already configured the random access configuration parameters for a slice intended by the terminal, the base station may adjust (e.g., modify) the random access configuration parameters for the slice, based on the random access report from the terminal. In case that the base station has already configured the random access configuration parameters for a slice that the terminal is not using, the base station may adjust (e.g., modify or delete) the random access configuration parameters for the slice, based on the random access report from the terminal. In case that the base station has not yet configured the random access configuration parameters for the slice intended by the terminal, the base station may adjust (e.g., newly configure) the random access configuration parameters for the slice, based on the random access report from the terminal.

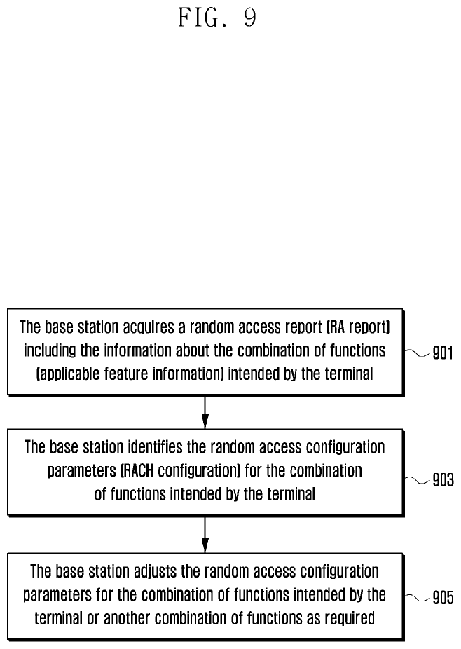

As described with reference to FIGS. 8 and 9, the random access report information from the terminal may be utilized for RACH optimization of the base station and network. For another example, the random access report information from the terminal may include at least one of the following: information indicating whether a collision occurred per random access attempt, information on the SSB on which the terminal attempted random access in chronological order and the number of random access preambles transmitted by the terminal on the SSB, or information indicating whether the SSB on which the terminal attempted random access exceeded or fell below the rsrp-ThresholdSSB threshold per random access attempt. The terminal may report the above information to the base station even when a random access procedure is performed for one or plurality of functions. Based on the random access report information from the termina, the base station configures the terminal with the random access configuration parameters for one or plurality of functions by adjusting parameters such as random access preamble configuration to be configured for one or plurality of functions, random access preamble transmission resources (frequency/time resources) to be configured for one or plurality of functions, SSB configuration on which the random access can be attempted for one or plurality of functions, rsrp-ThresholdSSB threshold for the SSB on which the random access to be attempted for one or plurality of functions, etc. Hereinafter, with reference to FIG. 9, an operation of a base station processing random access reports performed by the terminal for one or plurality of functions will be described.

FIG. 9 is a diagram illustrating an operation of a base station processing random access reports of a terminal for various functions according to various embodiments of the present disclosure.

Referring to FIG. 9, the base station may acquire a random access report from the terminal at step 901, and the random access report may include information on one or plurality of functions to which the terminal applied the random access procedure.

At step 903, the base station may acquire random access configuration parameters (RACH configuration) information included in the random access report from the terminal. Information that the base station may acquire through the random access report from the terminal at steps 901 to 903 may include at least one of the random access configuration parameters (RACH configuration) used in one or plurality of functions, for example, a random access partition (RA partition), or the usage states for the random access preamble. The base station may configure and reconfigure the information on one or plurality of functions to be provided to the terminal, and the random access configuration parameters for the one or plurality of functions, based on information on one or plurality of functions that was acquired through the random access report from the terminal at steps 901 to 903, and the random access configuration parameter information that was applied to one or plurality of functions.

At step 905, the base station may process allocation adjustment for random access configuration parameters (RACH configuration), for example, random access partition (RA partition), to be used for the combination of one or plurality of functions, and allocation adjustment for random access preambles. The base station may provide the terminal with the configured and reconfigured information on one or plurality of functions and the random access configuration parameters to be used in the random access procedure for one or plurality of functions.

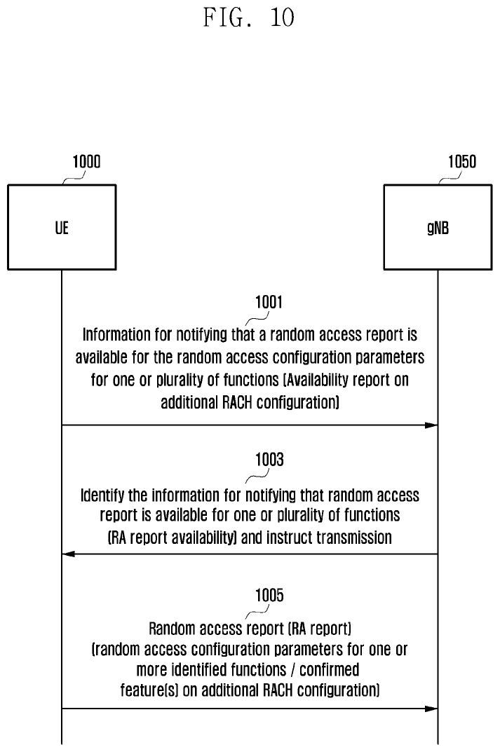

Meanwhile, the operation of the terminal and the base station performing random access reporting for one or plurality of functions according to the embodiments of FIGS. 6 to 9 may be performed when random access reporting event has occurred, in a case where the terminal is configured by the base station about whether the terminal is able to perform the random access reporting for one or plurality of functions and may perform the random access reporting for the one or plurality of functions. Hereinafter, with reference to FIG. 10, an example of configuring whether the terminal is able to perform the random access reporting for one or plurality of functions will be described.

FIG. 10 is a diagram illustrating signal flows between a terminal and a base station that process support information on random access reports for various functions according to various embodiments of the present disclosure.

Referring to FIG. 10, a terminal 1000 may transmit to a base station 1050 at step 1001 information for notifying that a random access report is available for the random access procedure performed using the random access configuration parameters (additional RACH configuration) for one or plurality of functions. The information (RA report availability) for notifying that the random access report is available that is transmitted by the terminal at step 1001 may include the combination of one or plurality of functions (feature or feature list) for which the terminal performed the random access procedure. The information (RA report availability) for notifying that the random access report is available for the one or plurality of functions at step 1001 may be included in an RRC message (e.g., at least one or a combination of the RRCSetupComplete message, the RRCResumeComplete message, and the RRCReconfigurationComplete message).

At step 1003, the base station 1050 may process (or, identify) the information (RA report availability) for notifying random access report availability for the one or plurality of functions of the terminal 1000, and may instruct the terminal 1000 to transmit a random access report. At step 1003, the base station 1050 may select and indicate one or plurality of functions that the terminal 1000 can report. Upon determining that the terminal 1000 has performed a random access procedure for one or plurality of functions and is instructed to perform random access reporting when it has performed a random access procedure using the random access configuration parameters for the one or plurality of functions as instructed at step 1003,

at step 1005, the terminal 1000 may transmit a random access report to the base station 1050 including the random access configuration parameters that were used in the random access procedure performed for the one or plurality of functions, etc. At step 1005, the terminal 1000 may configure and transmit the random access report for the one or plurality of functions that the base station 1050 instructed at step 1003.

Meanwhile, as an embodiment of the present disclosure, the base station may transmit a message to the terminal requesting a random access report for one or plurality of functions, and the terminal may transmit the random access report to the base station according to the request information on the random access report for one or plurality of functions from the base station.

The base station may transmit the UEInformationRequest message to the terminal as an example of a message requesting a random access report for one or plurality of functions. Upon acquiring the message requesting the random access report for one or plurality of functions from the base station, the terminal may perform the operations shown in [Table 16]. Meanwhile, the present disclosure is not limited to [Table 16] below.

TABLE 16
Upon receiving the UEInformationRequest message, the UE shall,
only after successful security activation:
* 1> if ra-ReportReq for featureCombination (and/or SliceGroup)
for one or more feature is set to true and the UE has random access
related information available in VarRA-Report for
featureCombination (and/or SliceGroup) and if the RPLMN is included
in plmn-IdentityList stored in VarRA-Report:
** 2> set the ra-ReportList in the UEInformationResponse message
to the value of ra-ReportList for featureCombination (and/or
SliceGroup) in VarRA-Report;
** 2> discard the ra-ReportList for featureCombination (and/or
SliceGroup) from VarRA-Report upon successful delivery of the
UEInformationResponse message confirmed by lower layers;
* 1> if connEstFailReportReq for featureCombination (and/or
SliceGroup) is set to true and the UE has connection establishment
failure or connection resume failure information in
VarConnEstFailReport for featureCombination (and/or SliceGroup)
or VarConnEstFailReportList for featureCombination (and/or
SliceGroup) and if the RPLMN is equal to plmn-Identity stored
in VarConnEstFailReport:
** 2> set timeSinceFailure in VarConnEstFailReport to the time that
elapsed since the last connection establishment failure or connection
resume failure in NR;
** 2> set the connEstFailReport for featureCombination (and/or
SliceGroup) in the UEInformationResponse message to the value of
connEstFailReport for featureCombination (and/or SliceGroup)
in VarConnEstFailReport;
** 2> for each connEstFailReport for featureCombination (and/or
SliceGroup) in the connEstFailReportList for featureCombination
(and/or SliceGroup) in VarConnEstFailReportList:
*** 3> set timeSinceFailure to the time that elapsed since the
associated connection establishment failure or connection
resume failure in NR;
** 2> for each connEstFailReport for featureCombination (and/or
SliceGroup) in the connEstFailReportList for featureCombination
(and/or SliceGroup) in the UEInformationResponse message, set the
value to the value of connEstFailReport for featureCombination
(and/or SliceGroup) in VarConnEstFailReport in
VarConnEstFailReportList except the last entry, if the content
of connEstFailReport for featureCombination (and/or SliceGroup)
in the VarConnEstFailReport is equal to the content of the last
entry in the VarConnEstFailReportList;
** 2> discard the connEstFailReport for featureCombination (and/or
SliceGroup) from VarConnEstFailReport and
VarConnEstFailReportList upon successful delivery of the
UEInformationResponse message confirmed by lower layers;

Although not shown in [Table 16], the base station may request the terminal to transmit a random access report for one or plurality of functions associated with the RLF-Report, and in this case, the terminal may configure an RLF-Report including a random access report for one or plurality of functions associated with the RLF-Report. The base station may request the terminal to transmit a random access report for one or plurality of functions associated with the SuccessHO-Report, and in this case, the terminal may configure a SuccessHO-Report including a random access report for one or plurality of functions associated with the SuccessHO-Report.

The random access report message for one or plurality of functions that the terminal transmits in response to a random access report request for one or plurality of functions from the base station as in the example of [Table 16] may include, for example, a UEInformationResponse message. The report message including the random access report information on one or plurality of functions of the terminal may include an example of [Table 17]. Meanwhile, the present disclosure is not limited to [Table 17] below, and information in [Table 17] may be referred to by other names.

TABLE 17
UEInformationResponse-r16-IEs ::= SEQUENCE {

| | |
|---|---|
| MeasResultIdleEUTRA-r16 MeasResultIdleEUTRA-r16 | OPTIONAL, |
| MeasResultIdleNR-r16 MeasResultIdleNR-r16 | OPTIONAL, |
| logMeasReport-r16 LogMeasReport-r16 | OPTIONAL, |
| connEstFailReport-r16 ConnEstFailReport-r16 | OPTIONAL, |
| ra-ReportList-r16 RA-ReportList-r16 | OPTIONAL, |
| rlf-Report-r16 RLF-Report-r16 | OPTIONAL, |
| mobilityHistoryReport-r16 MobilityHistoryReport-r16 | OPTIONAL, |
| lateNonCriticalExtension OCTET STRING | OPTIONAL, |
| nonCriticalExtension UEInformationResponse-v1700-IEs | OPTIONAL |

}

At least one or a combination of RA-ReportList-r16, ConnEstFailReport-r16,
RLF-Report-r16, SuccessHO-Report-r17 may include random access report
information on one or plurality of functions, and
RA-ReportList-r16 may include the information in [Table 6] to [Table 7].
ConnEstFailRerpot-r16 may include the information in [Table 9].
RLF-Report-r16 may include the information in [Table 11].
SuccessHO-Report-r17 may include the information in [Table 12].

Methods according to embodiments described in the claims or the description of the present disclosure may be implemented in the form of hardware, software, or a combination of hardware and software.

When implemented in software, a computer-readable storage medium that stores one or more programs (software modules) may be provided. One or more programs stored in the computer-readable storage medium are configured for execution by one or more processors in an electronic device. One or more programs include instructions that cause the electronic device to execute methods according to embodiments described in the claims or the description of the present disclosure.

These programs (software modules, software) may be stored in random access memory, non-volatile memory including flash memory, read only memory (ROM), and electrically erasable programmable ROM (EEPROM: Electrically Erasable Programmable Read Only Memory), magnetic disc storage device, Compact Disc-ROM (CD-ROM), Digital Versatile Discs (DVDs), or other types of optical storage device or magnetic cassette. Alternatively, these programs may be stored in a memory constituted by a combination of some or all of these. Additionally, the constituted memory may be included in plural.

Additionally, the programs may be stored in an attachable storage device that is accessible via a communication network, such as Internet, Intranet, Local Area Network (LAN), Wide LAN (WLAN), or Storage Area Network (SAN), or a combination thereof. The storage device may access a device performing the embodiments of the present disclosure via an external port. Additionally, a separate storage device on the communication network may access the device performing the embodiments of the present disclosure.

In the specific embodiments of the present disclosure described above, the components included in the disclosure are expressed in the singular or plural form according to the specific embodiments presented. However, the singular or plural expressions are selected appropriately for the presented situation for the convenience of explanation, and the present disclosure is not limited to the singular or plural components, and even if the components are expressed in the plural form, they may be constituted in the singular form, or even if the components are expressed in the singular form, they may be constituted in the plural form.

Meanwhile, specific embodiments have been described in the detailed description of the present disclosure, but of course, various modifications are possible without departing from the scope of the present disclosure. Therefore, the scope of the present disclosure should not be limited to the described embodiments but should be determined not only by the scope of the claims described later but also by the equivalents of the scope of the claims.

1-15. (canceled)

16. A method performed by a terminal in a wireless communication system, the method comprising:
receiving, from a base station, a random access configuration including parameters for a combination of a one or more features;
performing a random access procedure based on the random access configuration;
receiving, from the base station, a request message for a random access report; and
transmitting, to the base station, a response message including the random access report,
wherein, the random access report includes information on one or more features that triggers the random access procedure.

17. The method of claim 16,
wherein the random access report further includes information on a one or more features associated to a used random access resource, in case that the one or more features associated to the used random access resource is different from the one or more features that triggers the random access procedure.

18. The method of claim 16,
wherein in case that the random access procedure is triggered by a slicing, the information on the one or more features that triggers the random access procedure includes information on a slice group that triggers the random access procedure.

19. The method of claim 17,
wherein in case that a slicing is associated to the used random access resource, the information on the one or more features associated to the used random access resource includes information on a slice group associated to the used random access resource.

20. The method of claim 16,
wherein the one or more features includes at least one of redcap, small data, or slice group.

21. A method performed by a base station in a wireless communication system, the method comprising:
transmitting, to a terminal, random access configuration parameters for a combination of a one or more features;
transmitting, to the terminal, a request message for a random access report; and
receiving, from the terminal, a response message including the random access report,
wherein the random access report includes information on a one or more features that triggers a random access procedure performed by a terminal.

22. The method of claim 21,
wherein the random access report includes information on a one or more features associated to a used random access resource, in case that the one or more features associated to the used random access resource is different from the one or more features that triggers the random access procedure.

23. The method of claim 21,
wherein in case that the random access procedure is triggered by a slicing, the information on the one or more features that triggers the random access procedure includes information on a slice group that triggers the random access procedure.

24. The method of claim 22,
wherein in case that a slicing is associated to the used random access resource, the information on the one or more features associated to the used random access resource includes information on a slice group associated to the used random access resource.

25. The method of claim 21,
wherein the one or more features includes at least one of redcap, small data, or slice group.

26. A terminal in a wireless communication system, the terminal comprising:
a transceiver; and
a controller configured to:
receive, from a base station, a random access configuration including parameters for a combination of a one or more features, perform a random access procedure based on the random access configuration, receive, from the base station, a request message for a random access report, and transmit, to the base station, a response message including the random access report,
wherein, the random access report includes information on one or more features that triggers the random access procedure.

27. The terminal of claim 26,
wherein the random access report further includes information on a one or more features associated to a used random access resource, in case that the one or more features associated to the used random access resource is different from the one or more features that triggers the random access procedure.

28. The terminal of claim 26,
wherein in case that the random access procedure is triggered by a slicing, the information on the one or more features that triggers the random access procedure includes information on a slice group that triggers the random access procedure.

29. The terminal of claim 27,
wherein in case that a slicing is associated to the used random access resource, the information on the one or more features associated to the used random access resource includes information on a slice group associated to the used random access resource.

30. The terminal of claim 26,
wherein the one or more features includes at least one of redcap, small data, or slice group.

31. A base station in a wireless communication system, the base station comprising:
a transceiver; and
a controller configured to:
transmit, to a terminal, random access configuration parameters for a combination of a one or more features, transmit, to the terminal, a request message for a random access report, and receive, from the terminal, a response message including the random access report,
wherein the random access report includes information on a one or more features that triggers a random access procedure performed by a terminal.

32. The base station of claim 31,
wherein the random access report includes information on a one or more features associated to a used random access resource, in case that the one or more features associated to the used random access resource is different from the one or more features that triggers the random access procedure.

33. The base station of claim 31,
wherein in case that the random access procedure is triggered by a slicing, the information on the one or more features that triggers the random access procedure includes information on a slice group that triggers the random access procedure.

34. The base station of claim 32,
wherein in case that a slicing is associated to the used random access resource, the information on the one or more features associated to the used random access resource includes information on a slice group associated to the used random access resource.

35. The base station of claim 31,
wherein the one or more features includes at least one of redcap, small data, or slice group.
